(19) United States
(12) Patent Application Publication
(10) Pub. No.: US 2025/0265660 A1
(43) Pub. Date: Aug. 21, 2025

(54) SYSTEM AND METHOD OF CHARGE MANAGEMENT FOR ELECTRIC VEHICLE

(71) Applicants: Hyundai Motor Company, Seoul (KR); Kia Corporation, Seoul (KR)

(72) Inventors: Jaehyuk CHOI, Hwaseong-si (KR); Jun Woo PARK, Hwaseong-si (KR); Yoon Ho JANG, Hwaseong-si (KR); Geontae LEE, Hwaseong-si (KR)

(73) Assignees: Hyundai Motor Company, Seoul (KR); Kia Corporation, Seoul (KR)

(21) Appl. No.: 19/034,249

(22) Filed: Jan. 22, 2025

(30) Foreign Application Priority Data
Feb. 21, 2024 (KR) 10-2024-0024923

(51) Int. Cl. G06Q 50/06; G06Q 10/0631

(52) U.S. Cl. CPC G06Q 50/06; G06Q 10/06315

(57) ABSTRACT

A system and method for managing the charging device of an electric vehicle include predicting charging call of future electric vehicles through a ML model trained based on a dataset generated by preprocessing past charging call data, and optimizing the deployment of charging device based on the predicted charging call.

### CROSS-REFERENCE TO RELATED APPLICATION

The present application claims priority to Korean Patent Application No. 10-2024-0024923 filed on Feb. 21, 2024, the entire contents of which is incorporated herein for all purposes by this reference.

### BACKGROUND OF THE PRESENT DISCLOSURE

### Field of the Present Disclosure

The present disclosure relates to a system and method of charge management for electric vehicles.

### Description of Related Art

A mobile fast charger may be used to charge electric vehicles. The mobile fast charger can rapidly charge an electric vehicle where the electric vehicle is located, but a separate power supply for the fast charger is required, which increases weight and volume.

Alternatively, the mobile fast charging may be provided by utilizing the internal power supply of the electric vehicle provided with a charger rather than using a separate fast charger.

However, the problem is that if there is a long distance between charging demand of the electric vehicle and the location of the mobile fast charger, towing for charging will be necessary. To solve the present problem, charging vehicles for the mobile charging service need to be optimally deployed in places where there is a high demand of charging.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system for managing a charging device for an electric vehicle.

Various exemplary embodiments provide an method for managing a charging device for an electric vehicle.

Various exemplary embodiments provide a neural network processor.

According to various exemplary embodiments of the present disclosure, a system for managing a charging device for an electric vehicle is provided. The system includes: a neural network processor configured to predict a charging call with respect to the electric vehicle through a machine learning (ML) model trained based on a dataset generated by preprocessing past charging call data; and a deployment optimizer configured to optimize deployment of the charging device based on the predicted charging call.

The system may further include a feature engineering device configured to generate a spatiotemporal dataset for the charging call by removing outliers from the past charging call data.

When generating the spatiotemporal dataset for the charging call by removing the outliers from the past charging call data, the feature engineering device may be configured to generate a heatmap of call history by mapping the past charging call data to service areas with respect to a charging service for the electric vehicle.

When generating the heatmap of the call history by mapping the past charging call data to the service areas with respect to the charging service for the electric vehicle, the feature engineering device may be configured to collect the heatmap of the call history during a time window having a predetermined time size.

The neural network processor may be further configured to infer a charging call for a prediction period using a first ML model trained based on the dataset through supervised learning.

The neural network processor may be further configured to input n spatiotemporal datasets to the trained first ML model and check the inference result image output from the trained first ML model.

The inference result image output from the first ML model may be a prediction heatmap of counts of future charging calls.

The prediction heatmap may include at least one of a prediction heatmap for a next half-year, a prediction heatmap for a next quarter, and a prediction heatmap for a next month.

The neural network processor may be further configured to cluster the prediction heatmap through unsupervised learning using a second ML model.

When clustering the prediction heatmap through the unsupervised learning using the second ML model, the neural network processor may be configured to extract features from a clustered prediction heatmap using at least one convolution layer based on population density of service areas with respect to a charging service for the electric vehicle.

When clustering the prediction heatmap through the unsupervised learning using the second ML model, the neural network processor may be further configured to adjust the prediction heatmap based on status of chargers within the service areas.

The charging device may be included in a charging vehicle that provides a mobile charging service for the electric vehicle.

When optimizing the deployment of the charging device based on the predicted charging call, the deployment optimizer may be configured to provide a prediction heatmap of the predicted charging call to the charging vehicle including the charging device or a provider of the mobile charging service.

According to various exemplary embodiments of the present disclosure, a method for managing a charging device for an electric vehicle is provided. The method includes: predicting a charging call with respect to the electric vehicle through a machine learning (ML) model trained based on a dataset generated by preprocessing past charging call data; and optimizing deployment of the charging device based on the predicted charging call.

The dataset may include a heatmap of call history generated by mapping the past charging call data to service areas with respect to charging service for the electric vehicle.

When the heatmap of the call history is generated by mapping the past charging call data to the service areas with respect to the charging service for the electric vehicle, the heatmap of the call history may be collected during a time window of a predetermined time size.

The predicting of the charging call with respect to the electric vehicle through the trained ML model may include inferring a charging call during a prediction period using a first ML model trained based on the dataset through supervised learning.

The inferring of the charging call during the prediction period using the trained first ML model may include inputting n spatiotemporal datasets to the trained first ML model and check a prediction heatmap of counts of future charging calls output from the trained first ML model.

The prediction heatmap may include at least one of a prediction heatmap for a next half-year, a prediction heatmap for a next quarter, and a prediction heatmap for a next month.

According to various exemplary embodiments of the present disclosure, a neural network processor is provided. The neural network processor includes at least one processor; and a memory storing instructions configured to cause the at least one processor perform a process including: generating a prediction heatmap of charging calls during a prediction period using a first ML model trained through supervised learning based on a dataset about past charging call data; and clustering the prediction heatmap through unsupervised learning using a second ML model.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a charge management system according to various exemplary embodiments of the present disclosure.

FIG. 2 illustrates a method for managing the charge system of an electric vehicle according to various exemplary embodiments of the present disclosure.

FIG. 3 illustrates a method for generating a dataset for machine learning according to various exemplary embodiments of the present disclosure.

FIG. 4 illustrates a heatmap image of a charging call according to various exemplary embodiments of the present disclosure.

FIG. 5 illustrates a prediction heatmap image of a charging call according to various exemplary embodiments of the present disclosure.

FIG. 6 illustrates a method for determining a heatmap of charging call in a future period according to various exemplary embodiments of the present disclosure.

FIG. 7 illustrates an neural network running a machine learning model according to various exemplary embodiments of the present disclosure.

FIG. 8 illustrates a charge management system according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the accompanying drawing, various exemplary embodiments of the present disclosure will be described in detail and thus a person of an ordinary skill can easily practice it in the field of the present disclosure to which the present disclosure is included. However, present disclosure may be implemented in several different forms and is not limited to the exemplary embodiment described herein. Accordingly, the drawings and description are to be regarded as illustrative in nature and not restrictive, and like reference numerals designate like elements throughout the specification.

Furthermore, unless explicitly described to the contrary, the word “comprise”, and variations such as “comprises” or “comprising”, will be understood to imply the inclusion of stated elements but not the exclusion of any other elements.

In the present specification, “A or B”, “at least one of A and B”, “at least one of A or B”, “A, B, or C”, “at least one of A, B, and C”, and “at least one of A, B, or C” may each include any one of the items listed together in the corresponding phrase, or any possible combination thereof.

In the present specification, expressions described in the singular may be construed in the singular or plural unless an explicit expression such as “one” or “single” is used.

As used herein, “and/or” includes each and every combination of one or more of the recited elements.

In the specification, it will be understood that, although the terms “first,” “second,” and the like may be used herein to describe various elements, these elements should not be limited by these terms. These terms are only used to distinguish one element from another. For example, a first element could be termed a second element, and a second element could similarly be termed a first element without departing from the scope of the present disclosure.

In a flowchart described with reference to drawings in the present specification, the order of operations may be changed, several operations may be merged, some operations may be divided, and specific operations may not be performed.

An artificial intelligence (AI) model running on an neural network of the present disclosure is a machine learning model that learns at least one task, and may be implemented as a computer program executed by a processor. A task learned by the AI model may refer to a task to be solved through machine learning or a task to be performed through machine learning. The AI models may be implemented as computer programs running on computing devices, downloaded over a network, or sold in product form. Alternatively, the AI model can link with various devices through a network.

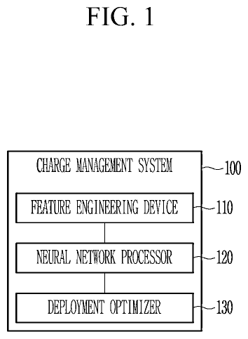

FIG. 1 illustrates a charge management system according to various exemplary embodiments of the present disclosure.

A charge management system 100 according to various exemplary embodiments of the present disclosure may improve the low cover rate to charge areas and reduce the towing cost of electric vehicles that have requested charging service by optimizing deployment of charging devices.

Referring to FIG. 1, the charge management system 100 according to various exemplary embodiments of the present disclosure may include a feature engineering device 110, an neural network processor 120, and a deployment optimizer 130.

In various exemplary embodiments of the present disclosure, the feature engineering device 110 may be configured to generate a spatiotemporal dataset for machine learning by preprocessing past charging call data. The past charging call data may include history data of charging call requested to charge the electric vehicles. The feature engineering device 110 may remove outliers from the past charging call data, determine spatial information and temporal information of the past charging call data, and generate a spatiotemporal dataset of the past charging call data. The feature engineering device 110 may also generate a heatmap of call history by mapping past charging call data to service areas with respect to a charging service for the electric vehicles.

In various exemplary embodiments of the present disclosure, the neural network processor 120 may train at least one machine learning (ML) model using a dataset generated by the feature engineering device 110, predict charging calls in future periods by use of the trained machine learning model, and generate a prediction heatmap that represents a prediction result of the charging calls.

In various exemplary embodiments of the present disclosure, the deployment optimizer 130 may optimize deployment of the charging devices based on a clustering result of the service areas. The charging device may be included in a charging vehicle that provides a mobile charging service to the electric vehicles. The charging vehicle may be operated by a party providing the mobile charging service. Alternatively, the charging vehicle may be a vehicle registered with intermediary for a person-to-person charging service.

By accurately predicting charging call by an area and period, information on areas with relatively large number of charging calls may be accurately provided, and the deployment of charging device for free or paid charging service may be optimized based on the prediction heatmap of charging call.

In an exemplary embodiment of the present disclosure, the feature engineering device 110, the neural network processor 120, and the deployment optimizer 130 may be implemented as a processor.

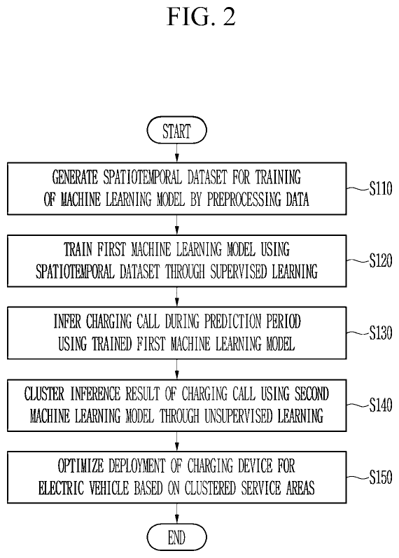

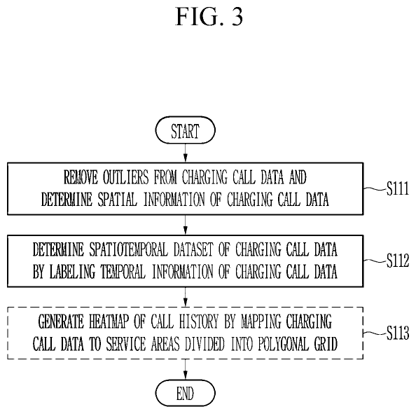

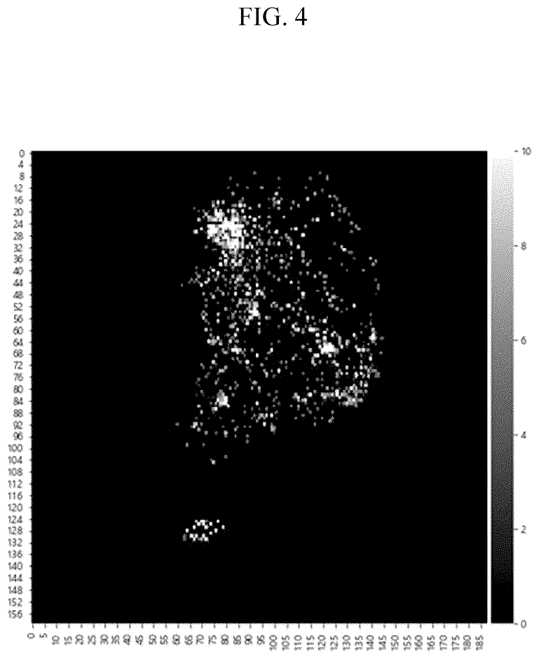

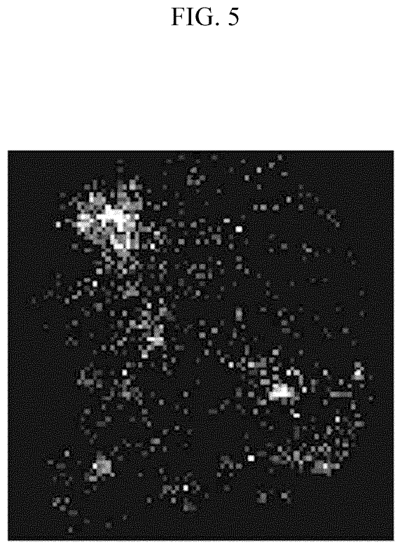

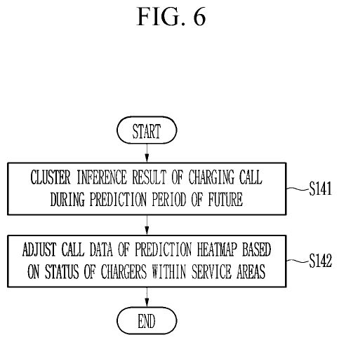

FIG. 2 is a flowchart showing a method for managing the charge system of an electric vehicle according to various exemplary embodiments of the present disclosure. FIG. 3 is a flowchart showing a method for generating a dataset for machine learning according to various exemplary embodiments of the present disclosure. FIG. 4 is a drawing showing a heatmap image of a charging call according to various exemplary embodiments of the present disclosure. FIG. 5 is a drawing showing a prediction heatmap image of a charging call according to various exemplary embodiments of the present disclosure. FIG. 6 is a flowchart showing a method for determining a heatmap of charging call in a future period according to various exemplary embodiments of the present disclosure.

Referring to FIG. 2, the charge management system 100 may be configured to generate a dataset for training the ML model by preprocessing call data (S110). Referring now to FIG. 3, the following describes in detail how the feature engineering device 110 of the charge management system 100 generates the dataset for training the ML model.

Referring to FIG. 3, the feature engineering device 110 of the charge management system 100 may remove outliers from the call data of the charging calls requested from the electric vehicles during the past period and determine the spatial information of the past charging call data (S111).

In various exemplary embodiments of the present disclosure, when the feature engineering device 110 determines the spatial information of the past charging call data, location information included in past charging call data may be used or location data may be added to the past charging call data. The call data of the charging calls requested from the electric vehicles during the past period may include a reception number, a reception time information, vehicle type information, and location information of the past charging call data. The feature engineering device 110 may be configured to determine the spatial information of the past charging call data using the location information of the past charging call data.

When the location information of the past charging call data is text indicating an administrative district, the feature engineering device 110 may add latitude and longitude data corresponding to the text of the administrative district as location data. For example, when the location information of the call data is ‘Yongpyeong-myeon, Pyeongchang-gun, Gangwon-do’, the feature engineering device 110 may be configured to determine the spatial information by adding 37.631052 for the latitude data and 128.452473 for the longitude data to the location data.

In various exemplary embodiments of the present disclosure, the feature engineering device 110 may be configured to determine the spatiotemporal dataset including the spatial information and the temporal information of the past charging call data by labeling the temporal information of the past charging call data (S112). In other words, the feature engineering device 110 may be configured to determine the spatiotemporal dataset that includes both spatial information and temporal information of the past charging call data.

In various exemplary embodiments of the present disclosure, the feature engineering device 110 may label past charging call data with temporal information that has a relatively large impact on the number of charging calls to determine the spatiotemporal dataset. In various exemplary embodiments of the present disclosure, year, month, and time in the reception time information of the charging call may have a relatively large influence on the number of charging calls and day and week in the reception time information may have relatively little influence on the number of charging calls. Accordingly, the feature engineering device 110 may sum the past charging call data for a predetermined number of days and label the spatiotemporal dataset generated from the summed past charging call data with time label, such as year, month, and time.

In various exemplary embodiments of the present disclosure, the feature engineering device 110 may sum the past charging call data over a time window of a predetermined time size (e.g., 6 hours).

Neighboring time windows may or may not overlap each other. For example, when the predetermined time size of the time window is 6-hour and each time window does not overlap each other, the feature engineering device 110 may sum the past charging call data through 4 time windows for 24 hours. Alternatively, the feature engineering device 110 may sum the past charging call data through 19 time windows for 24 hours a day when the predetermined time size of the time window is 6-hour and each time window overlaps each other at the maximum. The time label of the summed past charging call data may correspond to each time window. For example, time window 1 corresponds to 0:00-6:00, time window 2 corresponds to 1:00-7:00, and time window 19 corresponds to 18:00-24:00.

In various exemplary embodiments of the present disclosure, charging call data by day and charging call data by day of the week may not be significantly different, so they may be summed over the predetermined number of days. For example, the past charging call data for 10 days may be summed to generate 3 spatiotemporal datasets per month or the past charging call data for 15 days may be summed to generate 2 spatiotemporal datasets per month.

For example, when a spatiotemporal dataset is generated twice a month and four times a day (when the 6-hour time windows do not overlap) from the past charging call data for 4.5 years, the number of spatiotemporal datasets may be 432 (4.5 years×12 months× twice a month (at the beginning and end of the month)×4 times daily). Alternatively, when a spatiotemporal dataset is generated twice a month and 19 times a day (when the 6-hour time windows overlap at the maximum) from the past charging call data for 4.5 years, the number of spatiotemporal datasets may be 2,052 (4.5 years×12 months× twice a month (at the beginning and end of the month×19 times daily). At the instant time, each spatiotemporal dataset may be labeled with information such as the year, the month, whether the month is beginning or end, and the position of the time window.

In various exemplary embodiments of the present disclosure, the feature engineering device 110 may be configured to generate a heatmap of call history as the spatiotemporal dataset by mapping the past charging call data to the service areas with respect to the charging service (S113). The heatmap of the call history may include the temporal information and spatial information of the past charging call data.

In various exemplary embodiments of the present disclosure, the feature engineering device 110 may divide the service areas where the charging service is provided into a polygonal grid of a predetermined size to map the past charging call data to the service areas. In various exemplary embodiments of the present disclosure, the size of the polygonal grid may be a predetermined range of latitude and longitude or a predetermined distance (e.g., 5 km).

When the heatmap of the call history is generated as the spatiotemporal dataset, the spatiotemporal dataset may include a plurality of heatmap images that change over time. For example, when a spatiotemporal dataset is generated twice a month from the past charging call data for 4.5 years through 6-hour time windows, the spatiotemporal dataset may include 2,052 heatmap images.

Referring to FIG. 4, a heatmap generated as the spatiotemporal dataset by the feature engineering device 110 is depicted. In FIG. 4, the service areas are divided into quadrangle grid with a size of 5 km×5 km, and the number of charging call collected during a time window of a predetermined size in each quadrangle grid is displayed in grey scale.

Referring to FIG. 2, the charge management system 100 may train a first ML learning model using the spatiotemporal dataset (S120). In various exemplary embodiments of the present disclosure, the neural network processor 120 of the charge management system 100 may train the first ML model through supervised learning using heatmaps of the call history as the spatial dataset. At the instant time, the first ML model may be a prediction model for charging demand of the electric vehicles and may include Task-Guided Network (TGNet).

Afterwards, the charge management system 100 may be configured to predict a charging call of future using the trained first ML model (S130). The neural network processor 120 may infer the charging call during the prediction period of the future using the trained first ML model. The inference result output from the first ML model may include at least one of a prediction heatmap for a next half-year, a next quarter, and next month regarding the charge demand of the electric vehicles.

In various exemplary embodiments of the present disclosure, the neural network processor 120 may input n spatiotemporal datasets to the trained first ML model and check an image of the inference result output from the trained first ML model. The inferred result image may be a prediction heatmap of the number of future charging call. For example, the neural network processor 120 inputs 8 heatmaps of the number of calls over the past m years to the trained first ML model and generates 1 prediction heatmap of the number of future charging call from the trained first ML model.

Referring to FIG. 5, the prediction heatmap of the number of future charging calls output from the first ML model is shown.

In various exemplary embodiments of the present disclosure, a prediction period (e.g., next half-year, next quarter, next month) corresponding to the prediction heatmap output from the first ML model may be input in advance by the neural network processor 120. For example, the neural network processor 120 inputs n heatmaps of call histories over the past m years to the first ML model and inputs the prediction period of the second half of 2023 to the first ML model, so that the first ML model may output a prediction heatmap of charging calls for the next half year (in the instant case, the second half of 2023).

In various exemplary embodiments of the present disclosure, the neural network processor 120 may input predetermined n heatmaps (e.g., n=8) of call histories over the past m years to the first ML model. The time labels of n heatmaps of the past call histories may be different.

Referring to FIG. 2, the neural network processor 120 of the charge management system 100 may perform clustering through unsupervised learning using a second ML model on the inference result for the charging calls during the future prediction period (S140). In various exemplary embodiments of the present disclosure, when the inference result for the future charging calls is the prediction heatmap, the artificial neural network processor 120 may perform the clustering on the prediction heatmaps.

In various exemplary embodiments of the present disclosure, the neural network processor 120 may use a predetermined algorithm for clustering of the prediction heatmaps. The predetermined algorithm may include at least one of K-MEANS, DBSCAN, GMM, and MEAN-SHIFT.

In various exemplary embodiments of the present disclosure, the neural network processor 120 may use the past charging call data and the location information (e.g., latitude/longitude data) of charge stations (fixed types) for clustering of the prediction heatmaps.

Referring to FIG. 6, the neural network processor 120 of the charge management system 100 may perform clustering on the inference result of the charging calls during the future prediction period (S141). At the instant time, the neural network processor 120 may extract features from the clustered prediction heatmap using a convolution layer based on the population density of the service areas.

In various exemplary embodiments of the present disclosure, the neural network processor 120 may divide the service areas into sub-areas according to population and surface area and apply different parameters to the divided sub-areas. In other words, the neural network processor 120 may apply parameters corresponding to the divided sub-areas to unsupervised learning of the prediction heatmap. Table 1 below shows the relative values of the surface area and population of the sub-area.

TABLE 1

| Sub-area | Population | Surface area |
|---|---|---|
| 1 | ↑↑ | ↓ |
| 2 | ↑ | ↓ |
| 3 | ↑ | ↑ |
| 4 | ↓ | ↑↑ |

Furthermore, the neural network processor 120 may adjust the call data of the prediction heatmap based on the status of chargers within the service areas (S142). The charger may include a slow charger and a fast charger, and the neural network processor 120 may apply weight values of different sizes to the slow charger and the fast charger to adjust the prediction heatmap. Equation 1 below may represent a method for adjusting the call data of the heatmap of which features are extracted through the convolution layers.

$$Final call data = convolved call data - w 1 \times Slow charger - w 2 \times Fast charger \qquad ( Equation 1 )$$

Referring to FIG. 2, the deployment optimizer 130 of the charge management system 100 may optimize the deployment of the charging devices based on the clustered service areas (S150). The charge devices may include fixed charging device and mobile charging device. The charging device may be included in a charging vehicle that provides the mobile charging services to the electric vehicles. The charging device may provide at least one of free charging service, paid charging service, and P2P charging service for the electric vehicles.

The deployment optimizer 130 may provide the prediction heatmap of the predicted charging call to the charging vehicle or a service provider of mobile charging service to optimize the deployment of the charging devices.

As described above, the charge management system according to the exemplary embodiments of the present disclosure may be configured to predict charging calls by areas and periods to provide accurate providing information related to areas with relatively high number of charging calls and optimize the deployment of the charging devices for paid and free charging services based on the prediction heatmap of the charging calls.

Through the optimization of the deployment of the charging devices, satisfaction with the charging service may be improved and the cost of the towing service may be reduced. Furthermore, through the optimization of the deployment of the charging devices, it is possible to actively respond to emergency charge demands and alleviate problems related to lack of charging infrastructure.

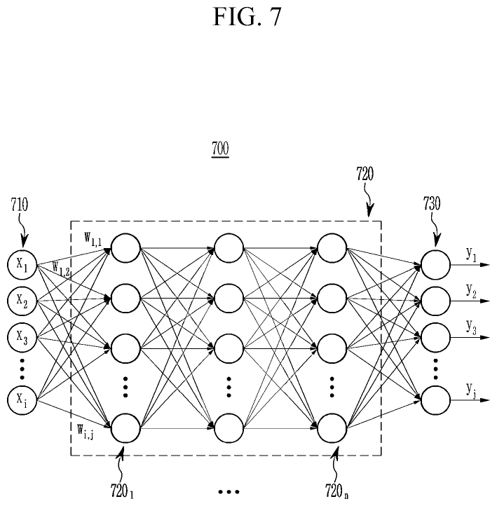

FIG. 7 illustrates an neural network running a ML model according to various exemplary embodiments of the present disclosure.

Referring to FIG. 7, the neural network (NN) 700 may include an input layer 710, a hidden layer 720, and an output layer 730. The input layer 710, the hidden layer 720, and the output layer 730 may each include a respective set of nodes, and strength of connections between the nodes may correspond to a weight (a connection weight wij). The nodes included in the input layer 710, the hidden layer 720, and the output layer 730 may be connected to each other with a fully connected type of architecture. The number of parameters (a weight and a bias) may be equal to the number of the connections in the neural network 700.

The input layer 710 may include input nodes (x₁ to xᵢ), and the number of the input nodes (x₁ to xᵢ) may correspond to the number of independent input variables. based on a training data set being input to the input layer 710 for training the neural network 700 and a test data set being input to the input layer 710 of the trained neural network 700, the output layer 730 of the trained neural network 700 may output an inferring/inference result.

The hidden layer 720 may be positioned between the input layer 710 and the output layer 730 and may include at least one hidden layer (7201 to 720n). The output layer 730 may include at least one output node (yᵢ to yⱼ). An activation function may be used in the hidden layer 720 and the output layer 730 to determine node outputs/activations. In an exemplary embodiment of the present disclosure, the neural network 700 may be learned by updating the weights of the hidden nodes included by the hidden layer 720.

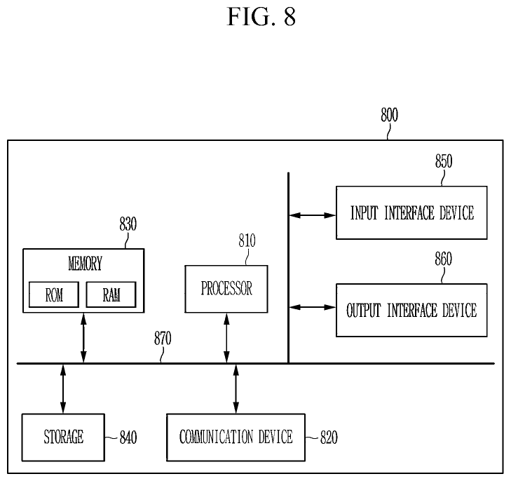

FIG. 8 illustrates a charge management system according to various exemplary embodiments of the present disclosure.

The charge management system may be implemented as a computer system, for example, a computer readable medium (but not a signal per se). Referring to FIG. 8, the computer system 800 may include at least one processor 810 and at least one memory 820. The memory 820 may be connected to the processor 810 and may store various information for driving the processor 810 or at least one program executed by the processor 810. Furthermore, the memory 820 may store instructions configured to cause the at least one processor perform a process including steps and/or methods described above.

The processor 810 may implement functions, stages, or methods provided in the exemplary embodiments of the present disclosure. An operation of the computer system 800 may be implemented by the processor 810. The at least one processor 810 may include at least one of CPU, GPU, and NPU. In practice the processor 810, may be one or more processors of one or more types.

The memory 820 may be provided inside and/or outside the processor and may be connected to the processor through various known means known. The memory may represent a volatile or non-volatile storage medium in various forms, and for example, the memory may include a read-only memory (ROM) and a random access memory (RAM).

The computing apparatuses, the electronic devices, the processors, the memories, the image sensors, the displays, the information output system and hardware, the storage devices, and other apparatuses, devices, units, modules, and components described herein with respect to FIGS. 1-9 are implemented by or representative of hardware components. Examples of hardware components which may be used to perform the operations described in the present application where appropriate include controllers, sensors, generators, drivers, memories, comparators, arithmetic logic units, adders, subtractors, multipliers, dividers, integrators, and any other electronic components configured to perform the operations described in the present application. In other examples, one or more of the hardware components that perform the operations described in the present application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices which is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in the present application. The hardware components may also access, manipulate, process, generate, and store data in response to execution of the instructions or software. For simplicity, the singular term “processor” or “computer” may be used in the description of the examples described in the present application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in the present application are performed by computing hardware, for example, by one or more processors or computers, implemented as described above implementing instructions or software to perform the operations described in the present application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code which is directly executed by the one or more processors or computers, such as machine code produced by a compiler. In another example, the instructions or software includes higher-level code which is executed by the one or more processors or computer using an interpreter. The instructions or software may be written using any programming language based on the block diagrams and the flow charts illustrated in the drawings and the corresponding descriptions herein, which include algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, Hard Disk Drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device which is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While the present disclosure includes specific examples, it will be apparent after an understanding of the present disclosure of The present application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for managing a charging device for an electric vehicle, the system comprising:
a neural network processor configured to predict a charging call with respect to the electric vehicle through a machine learning (ML) model trained based on a dataset generated by preprocessing past charging call data; and
a deployment optimizer configured to optimize deployment of the charging device based on the predicted charging call.

2. The system of claim 1, further including a feature engineering device configured to generate a spatiotemporal dataset for the charging call by removing outliers from the past charging call data.

3. The system of claim 2, wherein for the generating of the spatiotemporal dataset for the charging call by removing the outliers from the past charging call data, the feature engineering device is further configured to generate a heatmap of call history by mapping the past charging call data to service areas with respect to a charging service for the electric vehicle.

4. The system of claim 3, wherein for the generating of the heatmap of the call history by mapping the past charging call data to the service areas with respect to the charging service for the electric vehicle, the feature engineering device is further configured to collect the heatmap of the call history during a time window having a predetermined time size.

5. The system of claim 1,
wherein the machine learning (ML) model includes a first ML model, and
wherein the neural network processor is further configured to infer a charging call for a prediction period using the first ML model trained based on the dataset through supervised learning.

6. The system of claim 5, wherein the neural network processor is further configured to input n spatiotemporal datasets to the trained first ML model and check an inference result image output from the trained first ML model.

7. The system of claim 6, wherein the inference result image output from the first ML model is a prediction heatmap of counts of future charging calls.

8. The system of claim 7, wherein the prediction heatmap includes at least one of a prediction heatmap for a next half-year, a prediction heatmap for a next quarter, and a prediction heatmap for a next month.

9. The system of claim 7,
wherein the machine learning (ML) model includes a second ML model, and
wherein the neural network processor is further configured to cluster the prediction heatmap through unsupervised learning using the second ML model.

10. The system of claim 9, wherein for the clustering the prediction heatmap through the unsupervised learning using the second ML model, the neural network processor is further configured to extract features from a clustered prediction heatmap using at least one convolution layer based on population density of service areas with respect to a charging service for the electric vehicle.

11. The system of claim 10, wherein for the clustering of the prediction heatmap through the unsupervised learning using the second ML model, the neural network processor is further configured to adjust the prediction heatmap based on status of chargers within the service areas.

12. The system of claim 1, wherein the charging device is included in a charging vehicle that provides a mobile charging service for the electric vehicle.

13. The system of claim 12, wherein for the optimizing of the deployment of the charging device based on the predicted charging call, the deployment optimizer is further configured to provide a prediction heatmap of the predicted charging call to the charging vehicle including the charging device or a provider of the mobile charging service.

14. A method for managing a charging device for an electric vehicle, the method comprising:
predicting, by a processor, a charging call with respect to the electric vehicle through a machine learning (ML) model trained based on a dataset generated by preprocessing past charging call data; and
optimizing, by the processor, deployment of the charging device based on the predicted charging call.

15. The method of claim 1, wherein the dataset includes a heatmap of call history generated by mapping the past charging call data to service areas with respect to charging service for the electric vehicle.

16. The method of claim 15, wherein the generating of the heatmap of the call history by mapping the past charging call data to the service areas with respect to the charging service for the electric vehicle includes collecting the heatmap of the call history during a time window of a predetermined time size.

17. The method of claim 14,
wherein the predicting of the charging call with respect to the electric vehicle through the trained ML model includes inferring a charging call during a prediction period using the ML model trained based on the dataset through supervised learning.

18. The method of claim 17, wherein the inferring of the charging call during the prediction period using the trained ML model includes inputting n spatiotemporal datasets to the trained ML model and check a prediction heatmap of counts of future charging calls output from the trained ML model.

19. The method of claim 18, wherein the prediction heatmap includes at least one of a prediction heatmap for a next half-year, a prediction heatmap for a next quarter, and a prediction heatmap for a next month.

20. A neural network processor, comprising:
at least one processor; and
a memory storing instructions configured to cause the at least one processor perform a process including:
generating a prediction heatmap of charging calls during a prediction period using a first ML model trained through supervised learning based on a dataset about past charging call data; and
clustering the prediction heatmap through unsupervised learning using a second ML model.
